(19) United States
(12) Patent Application Publication
(10) Pub. No.: US 2006/0200500 A1
(43) Pub. Date: Sep. 7, 2006

(54) Method of efficiently recovering database

(75) Inventors: Sang Yeob Baek, Daegu (KR); Jong Eun Yun, Daegu (KR)

Correspondence Address: NIXON PEABODY, LLP, 401 9TH STREET, NW, SUITE 900, WASHINGTON, DC, 20004-2128, US

(73) Assignee: FUSIONSOFT CO., LTD., Daegu-si (KR)

(21) Appl. No.: 11/367,455

(22) Filed: Mar. 6, 2006

(30) Foreign Application Priority Data
Mar. 7, 2005 (KR) 10-2005-0018797

(51) Int. Cl. G06F 17/30

(52) U.S. Cl. 707/202

(57) ABSTRACT

A method of efficiently recovering a database that can be applied to a mobile communication terminal employing a flash memory as a storage medium is provided. In the flash memory, a database (DB) storage area and a DB recovery area are separately allocated. Images of pages in the DB storage area that are objects to be changed are sequentially read and stored in a memory buffer, and the original images of the pages before change are assigned sequential serial numbers and backed up in the DB recovery area. Then, the images of the pages in the memory buffer are changed according to a transaction. This series of jobs is performed with respect to all pages that are the objects of change. Then, each page in the DB storage area that is the object of the change is updated with a corresponding changed page in the memory buffer. If the mobile communication terminal is abnormally terminated without successfully performing this update, when the terminal is booted again, it is confirmed whether or not the serial number of the last page in the DB recovery area matches the total number of pages stored in the DB recovery area. If the serial number matches the total number, with the original image of the page before modification stored in the DB recovery area, the corresponding page in the DB storage area is recovered.

### BACKGROUND OF THE INVENTION

1. Field of the Invention

The present invention relates to a method of recovering a database in a computing apparatus employing a database management system, and more particularly, to a method of efficiently recovering a database that can be applied to a database management system installed in a mobile communication terminal employing a flash memory as a storage unit.

2. Description of the Related Art

With the recent development of multimedia and network fields, an embedded system has become to include functions for processing multimedia information and connecting a network, and the structure of the embedded system has become more complicated. In a simple embedded system used previously, a sequential design was good enough for simple functions. However, as the embedded system becomes complicated, a new method different from the conventional method is needed. As the jobs that should be processed increase, a multitasking function for a complicated system is needed, and an operating system (OS) used only in a computer system is now required in the embedded system. Furthermore, most of embedded systems were required to satisfy a characteristic of real time processing, and as a result, a real-time operation system (RTOS) has appeared.

The RTOS is an operating system that, if an event occurs inside and/or outside a system to which the RTOS is applied, makes a delay time from the occurrence of the event to a time when processing of the event begins, not exceed a predetermined time. In a system employing an RTOS (a real time system), an occurrence of an event and processing of the event are performed in real time, and a predetermined job is necessarily performed in a predetermined time. For example, mobile communication devices, such as a mobile communication terminal, a smart phone, a personal digital assistant (PDA), a wireless Internet terminal, and a car navigation system, and portable terminals for a special purpose, such as sales, marketing, and stock management, are real time system using the RTOS as other embedded systems.

Meanwhile, the variety of portable communication devices mentioned above, including the portable communication terminal, are continuously evolving and their functions are becoming more sophisticated and complicated. The portable communication devices have been changing and evolving continuously through fusion between heterogeneous devices, for example, fusion of a digital camera and a portable phone, fusion of an MP3 layer and a portable phone, and introduction of a TV reception function into a portable phone. In these portable communication devices, the amount of information to be managed and processed increases, and the contents of information processing jobs become more complicated, diversified, and sophisticated. Accordingly, in order to efficiently manage and process the information, introduction of means for performance improvement in terms of both hardware and software is needed, and as an example of these means, introduction of a database system can be considered.

However, so far there has been no precedence of introduction and commercialization of a database system in a portable communication terminal. In a conventional portable communication terminal, for example, a phone book is implemented by using a file system utilizing a data structure. However, when the trend and speed of evolution of a mobile communication terminal are considered, introduction of a database system into a mobile communication terminal can be regarded as a matter of time.

### SUMMARY OF THE INVENTION

Generally, when a query is processed in a database system, a log-based recovery method, and a shadow paging method are used in order to perform complete recovery from a variety of failures. Meanwhile, a mobile communication terminal is greatly limited by its execution speed. A response to a job request from a user should be performed within a predetermined time. Accordingly, the shadow paging method that can be performed simply may be more suitable and effective for recovery of a database mounted on a mobile terminal.

In order to ensure data integrity, a database system divides a storage space into a recovery area to store data for recovery and a storage area to store actually processed results, and manages the areas. When data integrity is destroyed due to abnormal termination of a mobile communication terminal, data in the database storage area is recovered with using the data stored in the recovery area of the database. A method of storing data in the recovery area of the database is guaranteed, for example, through a write-ahead long (WAL) protocol. In order to remove a side effect occurring when changed contents of a transaction that is not completed are stored in the storage area of a database, the unchanged original image is stored first in the recovery area of the database and the changed image of the page is stored in the storage area of the database according to the WAL protocol.

A flash file system generally used in a mobile communication terminal does not provide any special method in preparation for problems, for example, power loss or a phone reset, occurring in the middle of performing overwriting a predetermined file. Even though a recovery method to deal with changes in one file is implemented, if a transaction of a database requires changes in multiple files, the multiple files cannot be recovered at once. This means that data being modified may be lost.

According to the conventional method of recovering data of the database storage area using the shade paging method, as illustrated in FIG. 1A, header information is stored in a database recovery area 20 disposed separately from a database storage area 10, and when a problem occurs, the header information is checked to determine whether or not to recover data. However, this method has a problem that, if a flash file system does not support recovery of a single file, and if a header file is deleted due to a problem that occurs while the header file of the recovery area is updated, recovery cannot be completed.

In order to solve this problem, as illustrated in FIG. 1B, a flash memory space with a size the same as that of the data in a database storage area 30 is additional disposed to build a duplicated storage areas having another database storage area 40, and any one of the two storage areas 30 and 40 may be used for valid data. However, since this method requires a wider storage area, it is difficult for a mobile communication terminal that should efficiently use a limited memory space to employ this method.

The present invention provides a method of recovering a database by which each recovery file is stored together with information required for recovery, so that recovery of an original state before change can be successfully completed even though part of a file is lost due to abnormal termination, such as power supply stoppage, of a computing apparatus while a transaction is performed.

The present invention also provides a database recovery method requiring a less memory space and quickly and efficiently supporting recovery of a database, suitable for a mobile communication terminal environment employing a flash memory as a storage medium, in which the database is divided into files of a small size and input and/or output operations are performed in units of files.

According to an aspect of the present invention, there is provided a method of recovering a database, by which in a computing apparatus having a database management system which allocates a database storage area and a database recovery area separately in a data storing means, divides the database that is the object of management, into a plurality of page units of a smaller size, and performs input and/or output operations for the data storing means, if a failure occurs while the database management system performs a transaction, the database is recovered.

The method of recovering a database according to the present invention may be applied to a mobile communication terminal. In this case, a storage medium that can be employed as a data storing means may be a flash memory.

This method of recovering a database includes: sequentially reading images of pages in the database storage area that should be changed in order to perform the transaction, among the pages of the database in the database storage area, storing the read images in a memory buffer, assigning sequential serial numbers to the original images of the pages before change, backing up the original images in the database recovery area, then, changing the images of the pages in the memory buffer according to the transaction, and performing this series of jobs with respect to all pages that are the objects of change; updating each page in the database storage area that is the object of the change, with a corresponding page changed in the memory buffer; if the computing apparatus is abnormally terminated without successfully performing the updating operation, when the computing apparatus is booted again, confirming whether or not the serial number of the last page in the database recovery area matches the total number of pages stored in the database recovery area, and if the serial number matches the total number, with the original image of the page before modification stored in the database recovery area, recovering the corresponding page in the database storage area.

The recovering of the corresponding page in the database storage area may include: when the computing apparatus is booted again, reading the database recovery area and confirming whether or not data exists in the database recovery area; comparing the read total number of pages stored in the database recovery area with the serial number of the last page; if the two compared values are identical, with the original image of the page before modification stored in the database recovery area, recovering the corresponding page in the database storage area, and if the two values are different, deleting all pages stored in the database recovery area.

In the database recovery method, the serial numbers may be assigned to the pages backed up in the database recovery area such that, while one transaction is performed, by incrementing a serial number by 1 from 1, the serial number is assigned sequentially to each of all pages that should be changed according to the transaction, and if the transaction is completed, the serial numbers are reset.

Meanwhile, the size of the database may increase due to the contents changed during the transaction in relation to the database, and even in this case, complete recovery needs to be guaranteed. For this, when the original images of pages before change are backed up in the database recovery area together with the corresponding serial numbers, the size of the entire database before the transaction begins may be additionally stored together. In this case, if there are pages added due to the changed contents while the transaction is performed, pages, each having a page number greater than the size of the database before the transaction is performed is deleted. At the same time, recovery of other changed contents in relation to the transaction is performed by using the original images of the pages before the change that are backed up in the database recovery area. By doing so, even when pages increase due to the change, complete recovery can be guaranteed.

### BRIEF DESCRIPTION OF THE DRAWINGS

The above objects and advantages of the present invention will become more apparent by describing in detail preferred embodiments thereof with reference to the attached drawings in which:

FIGS. 1A and 1B illustrate a conventional method of recovering data with respect to a database;

FIG. 2 illustrates a method of utilizing an area of a flash memory employed in a method of recovering data of a database system installed in a mobile communication terminal according to an embodiment of the present invention;

FIG. 3 illustrates a file structure of a backup page that is used when a page to be changed is backed up in a database recovery area;

FIG. 4 illustrates a process of storing a page for recovery in a database recovery area and using the page for a recovery operation; and

FIG. 5 is a flowchart illustrating a recovery procedure when a database is recovered.

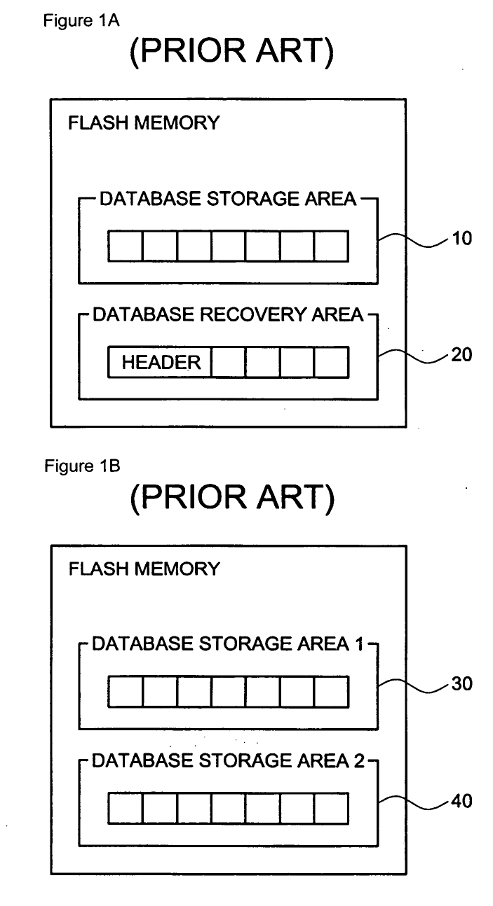

### DESCRIPTION OF THE PREFERRED EMBODIMENTS

The present invention will now be described more fully with reference to the accompanying drawings, in which an embodiment of the present invention is applied to a computing apparatus, such as a mobile communication terminal employing a database management system.

A mobile communication terminal mainly uses a flash memory as a storage medium. Accordingly, a database management system mounted on the mobile communication terminal stores data in the flash memory. A process of reading data from and storing data in the flash memory takes most of operation time in the database of the mobile communication terminal. When part of contents of a file recorded in the flash memory needs to be modified, the data of the part cannot be read or written separately due to the characteristic of the flash memory as a medium, and the entire contents of the recorded file should be read and the part can be modified. After the part is modified, again the entire contents of the changed file should be recorded in the flash memory. This process needs much more time to read and write again data, with the increasing size of data to be recorded. Furthermore, even though the actual change is limited to a part of a file, data should be transferred in units of files, such that the utilization of a memory space is degraded.

In a database management system operating based on a flash memory, a lump of a database file structure is divided into file units of a smaller size, for example, 2 KB or 4 KB, for efficient input and/or output operations, and input and/or output operations for the flash memory are performed. Also, when the database is recovered from an abnormal termination, the recovery operation is performed in units of the files. This is because of the input/output (I/O) characteristic of the flash memory described above. At this time, information on the size of the database is added to each file such that the information can be used when a recovery operation is performed.

Thus, the present invention relates to a method of recovering a database assuming that the method of dividing one database file structure of a large size into smaller pieces that are a plurality of page units of a small size and storing data in a flash memory is employed.

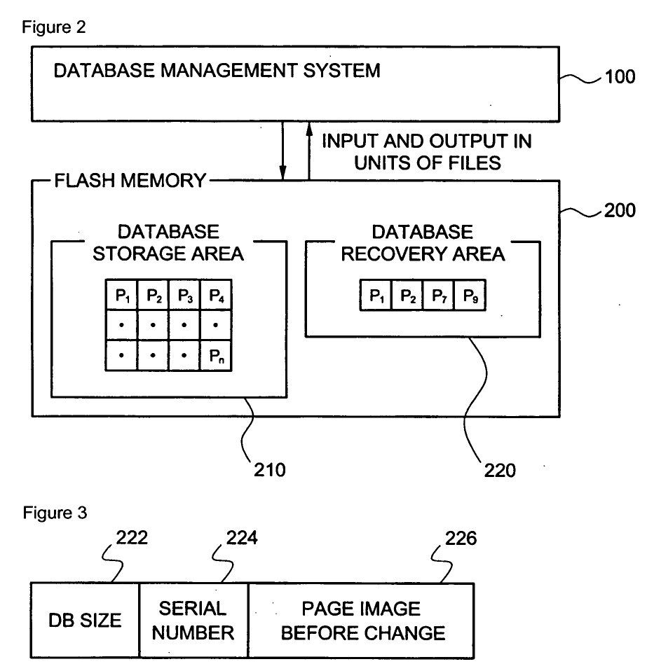

Referring to FIG. 2, the present invention uses a flash memory 200 as a storage unit of a database management system 100, in which a database storage area 210 and a database recovery area 220 are separately allocated in the flash memory 200. This is similar to the conventional method. That is, according to the conventional method, when one database file structure is divided into a plurality of smaller pieces and stored, separate file information for recovery should be stored in a database recovery area and in order to perform a recovery operation, the file information for recovery should be analyzed separately. However, the present invention does not follow the method of storing and utilizing header information for recovery in the database recovery area 220. The database recovery area 220 stores information required for data recovery according to a file structure suggested in the present invention as illustrated in FIG. 3.

One file in the flash memory 200 corresponds to one page in a database. Accordingly, hereinafter, ‘file’ and ‘page’, as terms having identical meanings, will be used interchangeably.

Referring to FIG. 3, in the present invention, when a predetermined page stored in the database storage area 210 is changed, the original image of the page before the change is stored in the database recovery area 220 together with the serial number of the page. Here, the serial number is the number of the page in backup data stored in the database recovery area 220. This serial number is sequentially assigned to each of the entire pages that should be changed in a transaction while the transaction is performed, by increasing the serial number from 1 by 1. If the transaction is completed, the serial numbers are reset. Accordingly, if part or all of the backup pages stored in the database recovery area 220 are not deleted, the total number of the backup pages is always the same as the serial number of the last backup page.

This information is used to determine whether or not recovery of a database is performed when a mobile communication terminal (the database management system 100) is abnormally terminated and is booted again. Furthermore, preferably, a file for recovery backed up in the database recovery area 220 further include information on the total size of the database before a transaction begins, in addition to the serial number and the original image. A method of utilizing the total size information of a database will be explained later.

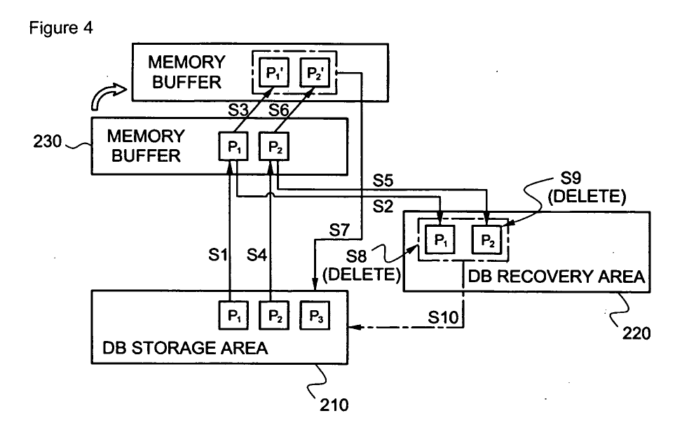

Referring to FIG. 4, it is assumed that an original database stored in the database storage area 210 before a transaction begins is divided into three pages (P₁, P₂, and P₃) and stored. It is also assumed that when an event in which a transaction needs to be performed in relation to this database occurs, pages to be changed are P₁, and P₂. In order to change the contents of these two pages, first, page P₁ that is the first object of the change is read from the database storage area 210 and loaded on a memory buffer 230 in operation S1. The original image of page P₁ before modification is stored in the database recovery area 220 in operation S2. Then, the contents of page P₁ in the memory buffer 230 is changed according to the contents of the transaction that should be performed in operation S3. In relation to page P₂ that is another object of the change, the same operation as that performed for page P₁ is repeated in operations S4, S5, and S6. Then, the contents of changed pages P₁′, and P₂′ stored at a time when the transaction commits are stored in the database storage area 210 in operation S7. If this storing operation is successfully performed, the two backup pages stored in the database recovery area 220 are deleted in operations S8 and S9. In this case, a recovery operation is not needed and the transaction is successfully completed.

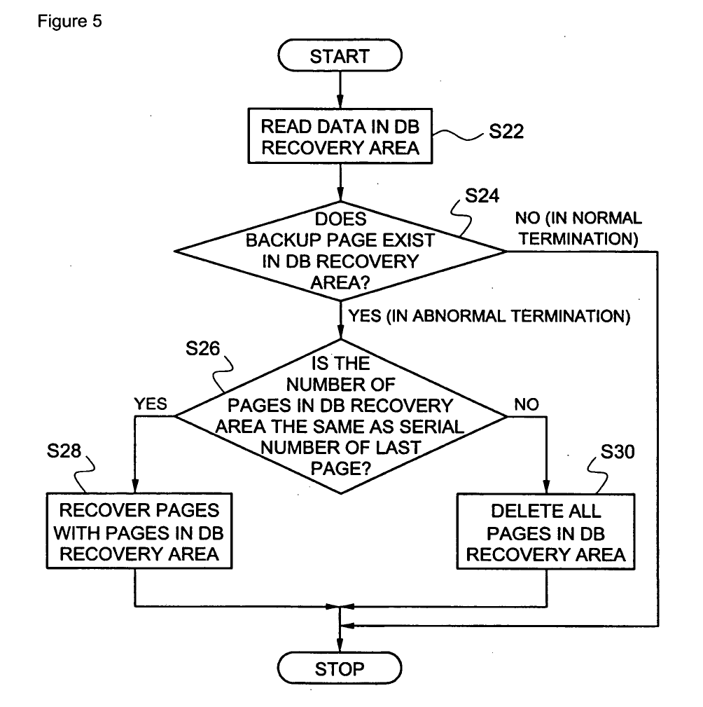

However, in the process of performing this series of operations, if the mobile communication terminal cannot be terminated normally due to a cause, such as a power supply stoppage, a problem that the change is not successfully made, or that storing the change page is not successfully performed occurs. In this case, by using the data stored in the database recovery area 220, i.e., P₁, and P₂, the original images of the pages that are the objects of the change, data in the database storage area 210 is recovered in operation S10. In the present invention, whether or not to perform a recovery operation is determined by comparing the total number of pages stored in the database recovery area 220 with the serial number of the last page (i.e., file) of the database recovery area 220. If the transaction in relation to the database is normally finished, all the data in the database recovery area 220 is deleted. If the transaction is not normally terminated due to an occurrence of a problem, such as a power failure, in the middle of the execution of the transaction, a recovery process as illustrated in FIG. 5 is performed when the mobile communication terminal is booted next time.

According to the method of recovering data of a database illustrated in FIG. 5 suggested by the present invention, first, data in the database recovery area 220 is read at an appropriate time in a process of rebooting the mobile communication terminal, and it is confirmed whether or not data (page) backed up exists in the database recovery area 220 in operations S22 and S24. Operations S8 and S9 to delete pages backed up in the database recovery area 220 are performed after changed pages in the memory buffer 230 are normally applied to the database storage area 210. Accordingly, if no backup pages exist in the database recovery area 220, it means that the page images (P₁, and P₂) before the change in the database storage area 210 are normally replaced with the pages (P₁′, and P₂′) changed in the execution of the transaction. That is, it means that the transaction is normally performed. Accordingly, no additional operation is needed.

Unlike this, if backup pages exist in the database recovery area 220, it means that the transaction is abnormally terminated due to a cause such as a power supply stoppage. In this case, a recovery procedure needs to be performed. In order to recover a database, the total number of pages (i.e., files) stored in the database recovery area 220 is compared with the serial number of the last page to determine whether or not the two values are identical in operation S26.

If the two information values compared in operation S26 are identical, with the backup pages stored in the database recovery area 220, corresponding pages stored in the database storage area 210 are replaced in operation S28. Since the original images of the pages before the change exist in the database recovery area 220 without being changed if the transaction is abnormally terminated, the state of the data before the change in the database storage area 210 can be recovered.

If the two information values compared in operation S26 are different to each other, all backup pages in the database recovery area 220 are deleted in operation S30. The reason for deleting all the backup pages is because it can be regarded that after the changed contents of the database were normally applied to the database storage area 210, a problem occurred in the process of deleting backup pages in the database recovery area 220.

Referring again to FIG. 4, the procedure of recovering the database storage area 210 can be broken down into the following several cases.

(1) When an abnormal termination occurs after operation S1 is performed:

Even though the database recovery area 220 is examined in operation S22 when the mobile communication terminal is booted the next time after the abnormal termination, backup pages do not exist in the database recovery area 220 in this case. Accordingly, a recovery procedure is not needed.

(2) When an abnormal termination occurs after operations S2 through S6 are performed:

If the database recovery area 220 is examined in operation S22 when the mobile communication terminal is booted the next time after the abnormal termination, backup pages exist in the database recovery area 220. In this case, the serial number of the last page in the database recovery area 220 is compared with the total number of pages in the database recovery area 220 in operation S26. Since the two information values are identical according to the result of the comparison, by performing a rollback according to operation S28, the state before the change of the database files can be recovered.

(3) When an abnormal termination occurs after operation S7 is performed:

If the database recovery area 220 is examined in operation S22 when the mobile communication terminal is booted the next time after the abnormal termination, backup pages exist in the database recovery area 220. In this case, if the serial number of the last page in the database recovery area 220 is compared with the total number of pages in the database recovery area 220, it is confirmed that the two values are identical. Accordingly, by performing a rollback according to operation S28, the state before the change of the database files in the database storage area 210 can be recovered. If operation S7 was performed, the transaction may have been completed, but it cannot be confirmed that the transaction has been successfully completed. That is, since the memory buffer 230 is cleared after the rebooting, it cannot be confirmed that all pages that should be changed are correctly applied to the database storage area 210. Accordingly, it is safe that a recovery operation is tried by regarding all operations to operation S8 for deleting data in the database recovery area 220 as not completed.

(4) When an abnormal termination occurs after operation S8 is performed:

In the database recovery area 220, one backup page (P1) is deleted and the other backup page (P2) remains. Accordingly, when the mobile communication terminal is abnormally terminated and booted the next time, the serial number (‘2’ in FIG. 4) of the last page in the database recovery area 220 is compared with the total number (‘1’ in FIG. 4) of pages in the database recovery area 220 in operation S26. Since the two values are not identical, the backup page remaining in the database recovery area 220 is all deleted in operation S30.

(5) When an abnormal termination occurs after operation S9 is performed:

Meanwhile, as described above, the total size information of the database before a transaction begins may be further included in the file for recovery backed up in the database recovery area 220, in addition to the serial number and the original image. The reason for further storing the total size information of the database is as follows. When necessary, the size of the database may increase due to the contents changed while the transaction is performed. For example, assuming that one page, P₂, increases to two pages (P₂′, and P₂′), each page added at this time will have a page number greater than those of the pages existing previously. If an error occurs in this process and a recovery operation should be performed, there will be no original images of the added pages. In this case, by using the stored “database size before the transaction begins”, the original database size is recovered. Since no original images of the added pages exist, if pages having pages numbers, each greater than the “database size before the transaction begins”, are deleted, the “original database size” before the change can be recovered. Other changed contents in relation to the same transaction are recovered by using the original images stored in the database recovery area 220. If this process is performed, the original state before the change of the database in the database storage area 210 is completed recovered.

With an example of the mobile communication terminal employing a flash memory as a storage medium, optimum embodiments of the present invention have been explained above. However, it is apparent that variations and modifications by those skilled in the art can be effected within the spirit and scope of the present invention defined in the appended claims. For example, the present invention can be applied not only to the mobile communication terminal, but also to a variety of computing apparatuses employing an embedded system utilizing a flash memory as a storage medium, and employing a database management system. Therefore, all variations and modifications equivalent to the appended claims are within the scope of the present invention.

The method of recovering a database according to the present invention can guarantee a complete recovery of a database through a simple comparison of the total number of backup pages stored in a recovery area with a serial number even when the database using a flash file system of a mobile communication terminal is abnormally terminated by a cause such as a power supply stoppage. That is, if only the serial number of a backup file as information required for recovery, and, when, necessary, the total size information of the database before change are retained, a complete recovery can be guaranteed. Accordingly, the present invention requires a less memory space for recovery and enables a faster recovery.

Furthermore, if data in the header information among data stored in a recovery area is lost, a recovery according to the conventional recovery method cannot be performed. However, according to the recovery method of the present invention, information required for recovery is stored together in each backup page, without recording header information separately, such that even though a predetermined backup page is damaged, data can be completely recovered by using only information on the serial number of the last backup page. In addition, the cost of writing a file is reduced such that the execution speed is enhanced.

What is claimed is:

1. A method of recovering a database when a failure occurs while a database management system performs a transaction, in a computing apparatus having the database management system which allocates a database storage area and a database recovery area separately in a data storing means, divides the database that is the object of management, into a plurality of page units of a smaller size, and performs input and/or output operations for the data storing means, the method comprising:
sequentially reading images of pages in the database storage area that should be changed in order to perform the transaction, among the pages of the database in the database storage area, storing the read images in a memory buffer, assigning sequential serial numbers to the original images of the pages before change, backing up the original images in the database recovery area, then, changing the images of the pages in the memory buffer according to the transaction, and performing this series of jobs with respect to all pages that are the objects of change;
updating each page in the database storage area that is the object of the change, with a corresponding page changed in the memory buffer; and
if the computing apparatus is abnormally terminated without successfully performing the updating operation, when the computing apparatus is booted again, confirming whether or not the serial number of the last page in the database recovery area matches the total number of pages stored in the database recovery area, and if the serial number matches the total number, with the original image of the page before modification stored in the database recovery area, recovering the corresponding page in the database storage area.

2. The method of claim 1, wherein the recovering of the corresponding page in the database storage area comprises:
when the computing apparatus is booted again, reading the database recovery area and confirming whether or not data exists in the database recovery area;
comparing the read total number of pages stored in the database recovery area with the serial number of the last page; and
if the two compared values are identical, with the original image of the page before modification stored in the database recovery area, recovering the corresponding page in the database storage area, and if the two values are different, deleting all pages stored in the database recovery area.

3. The method of claim 1, wherein the serial numbers are assigned to the pages backed up in the database recovery area such that, while one transaction is performed, by incrementing a serial number by 1 from 1, the serial number is assigned sequentially to each of all pages that should be changed according to the transaction, and if the transaction is completed, the serial numbers are reset.

4. The method of claim 1, wherein a flash memory is used as the data storing means.

5. The method of claim 1, wherein the computing apparatus is a mobile communication terminal.

6. The method of claim 1, wherein when the original images of pages before change are backed up in the database recovery area together with the corresponding serial numbers, the size of the entire database before the transaction begins is additionally stored together.

7. The method of claim 6, further comprising:
if there are pages added due to the changed contents while the transaction is performed, deleting pages, each having a page number greater than the size of the database before the transaction is performed, and at the same time, recovering other changed contents in relation to the transaction by using the original images of the pages before the change that are backed up in the database recovery area.

8. A method of recovering a database when a failure occurs while a database management system performs a transaction, in a mobile communication terminal having the database management system which allocates a database storage area and a database recovery area separately in a data storing means, divides the database that is the object of management, into a plurality of page units of a smaller size, and performs input and/or output operations for the data storing means, the method comprising:
sequentially reading images of pages in the database storage area that should be changed in order to perform the transaction, among the pages of the database in the database storage area, storing the read images in a memory buffer, assigning sequential serial numbers to the original images of the pages before change, backing up the original images in the database recovery area, then, changing the images of the pages in the memory buffer according to the transaction, and performing this series of jobs with respect to all pages that are the objects of change;
updating each page in the database storage area that is the object of the change, with a corresponding page changed in the memory buffer;
when the computing apparatus is booted again after the mobile communication terminal is abnormally terminated without successfully performing the updating operation, reading the database recovery area and confirming whether or not data exists in the database recovery area;
comparing the read total number of pages stored in the database recovery area with the serial number of the last page; and
if the two compared values are identical, with the original image of the page before modification stored in the database recovery area, recovering the corresponding page in the database storage area, and if the two values are different, deleting all pages stored in the database recovery area.

9. The method of claim 8, wherein the serial numbers are assigned to the pages backed up in the database recovery area such that, while one transaction is performed, by incrementing a serial number by 1 from 1, the serial number is assigned sequentially to each of all pages that should be changed according to the transaction, and if the transaction is completed, the serial numbers are reset.

10. The method of claim 8, wherein a flash memory is used as the data storing means.

11. The method of claim 8, wherein when the original images of pages before change are backed up in the database recovery area together with the corresponding serial numbers, the size of the entire database before the transaction begins is additionally stored together.

12. The method of claim 11, further comprising:
if there are pages added due to the changed contents while the transaction is performed, deleting pages, each having a page number greater than the size of the database before the transaction is performed, and at the same time, recovering other changed contents in relation to the transaction by using the original images of the pages before the change that are backed up in the database recovery area.

13. A method of recovering a database when a failure occurs while a database management system performs a transaction, in a computing apparatus having the database management system which allocates a database storage area and a database recovery area separately in a data storing means, divides the database that is the object of management, into a plurality of page units of a smaller size, and performs input and/or output operations for the data storing means, the method comprising:
sequentially reading images of pages in the database storage area that should be changed in order to perform the transaction, among the pages of the database in the database storage area, storing the read images in a memory buffer, assigning sequential serial numbers to the original images of the pages before change, backing up the original images in the database recovery area, then, changing the images of the pages in the memory buffer according to the transaction, and performing this series of jobs with respect to all pages that are the objects of change;
updating each page in the database storage area that is the object of the change, with a corresponding page changed in the memory buffer; and
if the computing apparatus is abnormally terminated without successfully performing the updating operation, when the computing apparatus is booted again, confirming whether or not the serial number of the last page in the database recovery area matches the total number of pages stored in the database recovery area, and if the serial number matches the total number, with the original image of the page before modification stored in the database recovery area, recovering the corresponding page in the database storage area,
wherein the serial numbers are assigned to the pages backed up in the database recovery area such that, while one transaction is performed, by incrementing a serial number by 1 from 1, the serial number is assigned sequentially to each of all pages that should be changed according to the transaction, and if the transaction is completed, the serial numbers are reset, and
when the original images of pages before change are backed up in the database recovery area together with the corresponding serial numbers, the size of the entire database before the transaction begins is additionally stored together.

14. The method of claim 13, further comprising:
if there are pages added due to the changed contents while the transaction is performed, deleting pages, each having a page number greater than the size of the database before the transaction is performed, and at the same time, recovering other changed contents in relation to the transaction by using the original images of the pages before the change that are backed up in the database recovery area.

15. The method of claim 13, wherein the recovering of the corresponding page in the database storage area comprises:
when the computing apparatus is booted again, reading the database recovery area and confirming whether or not data exists in the database recovery area;
comparing the read total number of pages stored in the database recovery area with the serial number of the last page; and
if the two compared values are identical, with the original image of the page before modification stored in the database recovery area, recovering the corresponding page in the database storage area, and if the two values are different, deleting all pages stored in the database recovery area.

16. The method of claim 13, wherein a flash memory is used as the data storing means.

17. The method of claim 13, wherein the computing apparatus is a mobile communication terminal.
